(19) United States
(12) Patent Application Publication
(10) Pub. No.: US 2018/0179313 A1
(43) Pub. Date: Jun. 28, 2018

(54) THERMOPLASTIC RESIN COMPOSITION AND MOLDING PRODUCT MADE THEREFROM

(71) Applicant: Chi Mei Corporation, Tainan City (TW)

(72) Inventors: An-Kai Su, Tainan City (TW); Jui-Hsi Hsu, Tainan City (TW); Po-Shih Wang, Tainan City (TW)

(73) Assignee: Chi Mei Corporation, Tainan City (TW)

(21) Appl. No.: 15/822,233

(22) Filed: Nov. 27, 2017

(30) Foreign Application Priority Data
Dec. 23, 2016 (TW) 105142870

(51) Int. Cl. C08F 212/08

(52) U.S. Cl. CPC C08F 212/08

(57) ABSTRACT

A thermoplastic resin composition and a molding product made therefrom are provided in the invention. The thermoplastic resin composition includes a branched copolymer obtained from a copolymerization of an unsaturated urethane compound and a copolymerizable monomer, wherein the unsaturated urethane compound includes a compound obtained from a reaction of a methacrylate compound containing a hydroxyl group and a triisocyanate cyclic compound.

### CROSS-REFERENCE TO RELATED APPLICATION

This application claims the priority benefit of Taiwan application serial no. 105142870, filed on Dec. 23, 2016. The entirety of the above-mentioned patent application is hereby incorporated by reference herein and made a part of this specification.

### BACKGROUND OF THE INVENTION

### 1. Field of the Invention

The invention generally relates to a thermoplastic resin composition, in particular, to a thermoplastic resin composition and a molding product made therefrom, and a manufacturing method of the thermoplastic resin composition.

### 2. Description of Related Art

In recent years, thermoplastic resin was shown to have good molding properties, physical and mechanical properties. In particular, one of its features is to have a good appearance and gloss in the molded product. Therefore, thermoplastic resin has been widely applied in different fields, such as in household appliances, mechanical parts, office supplies, electronic components and in the automotive industry etc.

In general, thermoplastic resin can be processed by using molding methods such as injection molding, extrusion molding and blow extension molding etc. In addition, during specific molding processes, the resin needs to be compressed into a sheet prior to molding. In order to fulfill such a requirement, the resin needs to have a high melt strength (i.e., increase the molecular weight of the resin), such that a good thickness uniformity and dimension stability during thermoforming or vacuum forming can be maintained.

However, after increasing the molecular weight of the resin, many drawbacks may arise such as the decrease in mobility, deterioration of the molding properties and reduced productivity etc. To overcome such drawbacks, a general way is to add branching agents for improvement. In conventional techniques, the added branching agents is multifunctional reactive monomers such as polyvalent acrylate compounds. However, in conventional techniques, the performance of the resin products on the heat resistance is still insufficient. After a number of high-temperature extrusion, the molecular weight of the resin decreases significantly.

Based on the above, how to make a molding product having high heat resistance to aid in the production stability is an issue that a person skilled in the art seeks to resolve.

### SUMMARY OF THE INVENTION

The invention provides a thermoplastic resin composition, including branched copolymer, being able to make the molding product have high heat resistance and aid in the improvement of production stability, and a manufacturing method of the thermoplastic resin composition.

The invention provides a thermoplastic resin composition including a branched copolymer obtained from a copolymerization of an unsaturated urethane compound and a copolymerizable monomer, wherein the unsaturated urethane compound includes a compound obtained from a reaction of a methacrylate compound containing a hydroxyl group and a triisocyanate cyclic compound.

The invention also provides a molding product, made from the above-mentioned thermoplastic resin composition.

The invention further provides a manufacturing method of the above-mentioned thermoplastic resin composition.

Based on the above, the thermoplastic resin composition provided by the invention includes the branched copolymer obtained from a copolymerization of an unsaturated urethane compound and a copolymerizable monomer, wherein the unsaturated urethane compound has the effect of a branching agent in polymer synthesis, so that the polymer transforms into a branched structure from a linear structure, and the molding product has high heat resistance, the production stability can be aided.

To make the above features and advantages of the invention more comprehensible, several embodiments accompanied with drawings are described in detail as follows.

### DESCRIPTION OF THE EMBODIMENTS

In the following, the embodiments of the invention are described. However, the embodiments are illustrative only, and the disclosure of the invention is not limited thereto.

In the specification and scope of patent applications of the invention, the term “(meth)acrylate” represents “acrylate and/or methacrylate”.

In the specification, if a group is not specifically described as being substituted or not, the group can represent a substituted group or an unsubstituted group. For example, “alkyl” can represent a substituted or unsubstituted alkyl, “alkylene group” can represent a substituted or unsubstituted alkylene group. In addition, if a group is described as “C_{X}”, it is represented that the backbone of the group has X carbon atoms.

The invention provides a thermoplastic resin composition including a branched copolymer obtained from a copolymerization of an unsaturated urethane compound and a copolymerizable monomer, wherein the unsaturated urethane compound includes a compound obtained from a reaction of a methacrylate compound containing a hydroxyl group and a triisocyanate cyclic compound.

Specifically, in an embodiment, the methacrylate compound containing a hydroxyl group and a triisocyanate cyclic compound are used as reactants to perform an urethanization reaction to produce the unsaturated urethane compound. Then, the unsaturated urethane compound and the copolymerizable monomer are used as reactants to perform the copolymerization reaction to produce the branched copolymer.

In the following, detailed descriptions about each of the components are described.

### Methacrylate Compound Containing a Hydroxyl Group

In an embodiment of the invention, the methacrylate compound containing a hydroxyl group includes at least one selected from a group consisting of 2-hydroxyethyl methacrylate and pentaerythritol trimethacrylate.

The chemical structure of 2-hydroxyethyl methacrylate (HEMA) is illustrated as below:

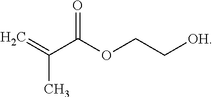

The chemical structure of pentaerythritol trimethacrylate (PETMA) is illustrated as below:

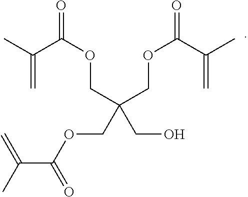 [SMILES: C=C(C)C(=O)OCC(CO)(COC(=O)C(=C)C)COC(=O)C(=C)C]

In an embodiment of the invention, the ethenyl group on the methacrylate compound containing a hydroxyl group has a methyl substituent.

### Triisocyanate Cyclic Compound

In an embodiment of the invention, the triisocyanate cyclic compound is represented by formula (1),

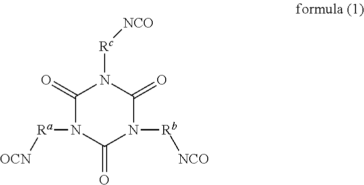

in formula (1), R^{a}, R^{b}, and R^{c} each independently represents a C₂˜C₁₂ alkylene group.

More specifically, in formula (1), R^{a}, R^{b}, R^{c} are each independently —(CH₂)ₙ—, preferably, n is a integer of 2 to 12; more preferably, n is a integer of 4 to 8; most preferably, n is 6.

In an embodiment of the invention, the triisocyanate cyclic compound is HDT (HDI isocyanurate trimer, HDI is shortening of hexamethylene diisocyanate), the structure thereof is represented as follow:

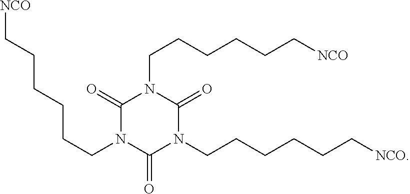

### Unsaturated Urethane Compound

In an embodiment of the invention, the unsaturated urethane compound includes a compound obtained from a reaction of a methacrylate compound containing a hydroxyl group and a triisocyanate cyclic compound.

In an embodiment of the invention, the unsaturated urethane compound is represented by formula (2),

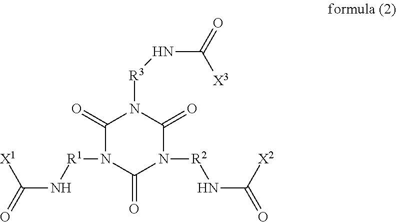

in formula (2), R¹, R² and R³ each independently represents a C₂˜C₁₂ alkylene group, and X¹, X² and X³ are each independently selected from a group consisting of a residue obtained by removing a hydrogen from a hydroxyl group of 2-hydroxyethyl methacrylate and a residue obtained by removing a hydrogen from a hydroxyl group of pentaerythritol trimethacrylate.

The specific structure of the residue obtained by removing a hydrogen from a hydroxyl group of 2-hydroxyethyl methacrylate is represented as follow:

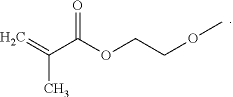

The specific structure of the residue obtained by removing a hydrogen from a hydroxyl group of pentaerythritol trimethacrylate is represented as follow:

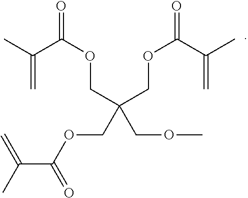 [SMILES: C=C(C)C(=O)OCC(COC)(COC(=O)C(=C)C)COC(=O)C(=C)C]

In an embodiment of the invention, the oxygen atom on the hydroxyl group (—OH) of the methacrylate compound containing a hydroxyl group bonds with the carbon atom on the isocyanate groups (—N═C═O) of the triisocyanate cyclic compound, to form the unsaturated urethane compound of the invention.

In an embodiment of the invention, R¹, R², and R³ each independently represents a C₂˜C₁₀ alkylene group. That is, R¹, R² and R³ are each independently —(CH₂)ₙ—, n is a integer of 2 to 10.

In an embodiment of the invention, R¹, R², and R³ each independently represents a C₄˜C₈ alkylene group. That is, R¹, R² and R³ are each independently —(CH₂)ₙ—, n is a integer of 4 to 8.

In an embodiment of the invention, R¹, R², and R³ are each independently a hexamethylene group. That is, R¹, R² and R³ are each independently —(CH₂)ₙ—, n is 6.

In an embodiment of the invention, the unsaturated urethane compound is represented by formula (3) or formula (4):

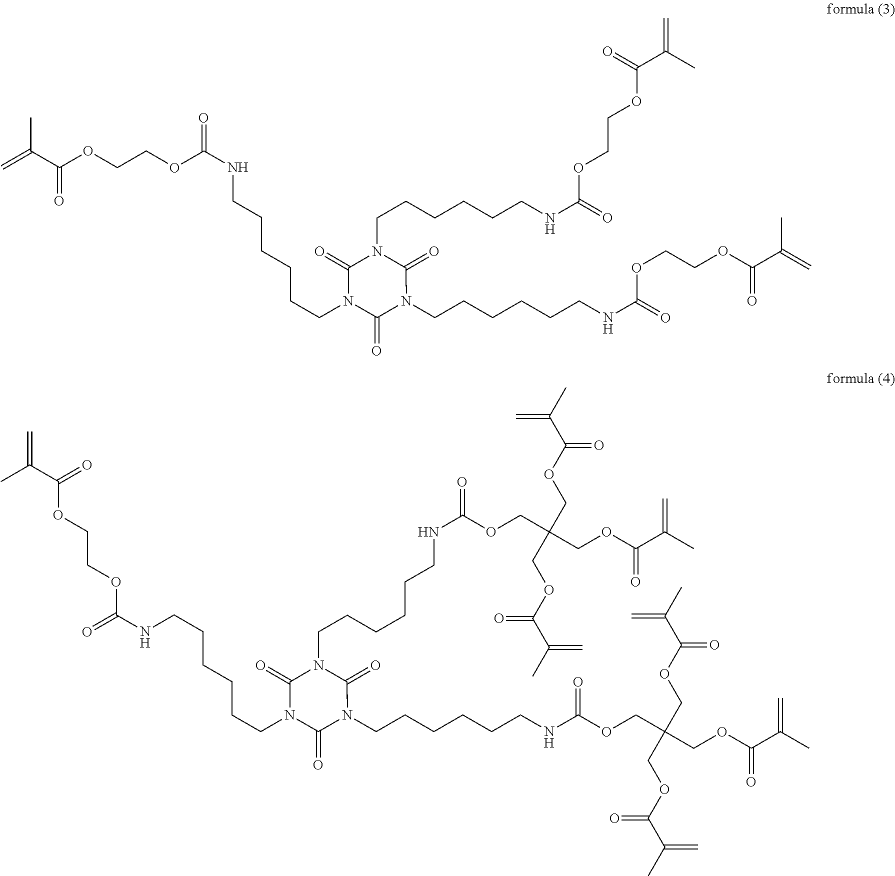

The unsaturated urethane compound represented by formula (3) is obtained from a reaction of 2-hydroxyethyl methacrylate and triisocyanate cyclic compound HDT.

The unsaturated urethane compound represented by formula (4) is obtained from a reaction of 2-hydroxyethyl methacrylate, pentaerythritol trimethacrylate and triisocyanate cyclic compound HDT.

In an embodiment of the invention, the ethenyl group on the unsaturated urethane compound has a methyl substituent.

The unsaturated urethane compound is configured to react with the copolymerizable monomer to form the branched copolymer, that is, the unsaturated urethane compound has the effect of the branching agent, so that the molding product has high heat resistance, and the production stability can be aided.

### Copolymerizable Monomer

The copolymerizable monomer of the invention includes at least one selected from a group consisting of a styrene based monomer, an acrylonitrile based monomer and a (meth)acrylate based monomer.

Specific examples of the styrene based monomer may include but are not limited to styrene, α-methyl styrene, p-tert-butyl styrene, p-methyl styrene, o-methyl styrene, m-methyl styrene, 2,4-dimethyl styrene, ethyl styrene, α-methyl-p-methyl styrene or bromostyrene. Preferably, the styrene based monomer is styrene, α-methyl styrene, or a combination thereof. The styrene based monomer used in the invention can be employed as a single monomer, or may be used in a combination of two or more of the monomers.

The acrylonitrile based monomer may be used alone or used in combination. And, the acrylonitrile based monomer may include but are not limited to acrylonitrile or α-methyl acrylonitrile. Preferably, the acrylonitrile based monomer is acrylonitrile.

Specific examples of the (meth)acrylate based monomer may include but are not limited to methyl acrylate, ethyl acrylate, isopropyl acrylate, butyl acrylate, polyethylene glycol diacrylate, methyl methacrylate, ethyl methacrylate, propyl methacrylate, butyl methacrylate, benzyl methacrylate, hexyl methacrylate, cyclohexyl methacrylate, dodecyl methacrylate, 2-hydroxyethyl methacrylate, glycidyl methacrylate, dimethylaminoethyl methacrylate, ethylene dimethacrylate or neopentyl dimethacrylate etc. Preferably, the (meth)acrylate based monomer is butyl acrylate, methyl methacrylate and butyl methacrylate.

### Branched Copolymer

The branched copolymer can be obtained from a copolymerization of the unsaturated urethane compound and the copolymerizable monomer, wherein the unsaturated urethane compound has the effect of a branching agent.

In an embodiment of the invention, based on an amount of the copolymerizable monomer being 100 parts by weight, an amount of the unsaturated urethane compound can be 0.001 parts by weight to 0.8 parts by weight.

In an embodiment of the invention, based on an amount of the copolymerizable monomer being 100 parts by weight, an amount of the unsaturated urethane compound is preferably 0.002 parts by weight to 0.4 parts by weight.

### Thermoplastic Resin Composition

The thermoplastic resin composition of the invention includes the branched copolymer.

In an embodiment of the invention, a weight average molecular weight of the thermoplastic resin composition can be 380,000 to 445,000.

### Molding Product

The invention also provides a molding product, made from the above-mentioned thermoplastic resin composition. The manufacturing method of the molding product is not particularly limited, and thermoforming or vacuum forming or the combination of the above process may be used. Conventional methods may be used in thermoforming and vacuum forming, hence, the description thereof will not be repeated herein.

The following experimental examples will be used to describe the thermal plastic resin composition of the invention. However, the following experimental examples are not intended to limit the invention.

### Synthesis of Unsaturated Urethane Compound

### Synthesis Example 1

Synthesis of the compound represented by formula (3): 2.2 parts by weight of MEHQ (Monomethyl ether hydroquinone), 1200 parts by weight of HDT (trade mark Desmodur® N3300, which is a trimer of hexamethylene diisocyanate (simplified as HDI)) manufactured by Bayer, 2081 parts by weight of EB (Ethylbenzene) and 2.2 parts by weight of DBDTL (Dibutyltin dilaurate) were added to a four-opening reaction bottle, and well stirred into a mixture solution. Then, 878.4 parts by weight of 2-hydroxyethyl methacrylate were slowly added to the mixture solution in room temperature, then the temperature is increased to 50° C. to react for 1 hour. Then the temperature was increased to 75° C. to react for 5 hours, after the reaction was completed, the temperature was reduced to room temperature, and the resulting product was collected by filtration, to obtain the compound represented by formula (3).

### Synthesis Example 2

Synthesis of the compound represented by formula (4): 2 parts by weight of MEHQ (Monomethyl ether hydroquinone), 720 parts by weight of HDT (trade mark Desmodur® N3300, which is a trimer of hexamethylene diisocyanate (simplified as HDI)) manufactured by Bayer, 920.5 parts by weight of EB (Ethylbenzene) and 2 parts by weight of DBDTL (Dibutyltin dilaurate) were added to a four-opening reaction bottle, and well stirred into a mixture solution. Then, 196.5 parts by weight of 2-hydroxyethyl methacrylate were slowly added to the mixture solution in room temperature, then the temperature is increased to 50° C. to react for 1 hour. Then, 940 parts by weight of pentaerythritol trimethacrylate (trade mark EM335) manufactured by Eternal Materials Co., Ltd. was dissolved in 940 parts by weight of EB, and added dropwisely to participate in the reaction. Then, the temperature was increased to 75° C. to react for 5 hours, and decreased to room temperature after the reaction was completed. Then, the resultant was collected by filtration, and the compound represented by formula (4) was obtained.

### Synthesis of Thermoplastic Resin Composition

### Embodiment 1

In 100 parts by weight of styrene monomer and 8 parts by weight of ethylbenzene, 150 ppm of 1,1-di-tert-butyl peroxy-3,3,5-trimethylcyclohexane (TX-29A), 250 ppm of n-dodecyl mercaptan, and 110 ppm of octadecyl-3-(3′,5′-di-t-butyl-4′-hydroxyphenyl)propionate (IX-1076, manufactured by CIBA) were added, and in the presence of 220 ppm of tri-(2,4-di-t-butyl-phenyl)phosphate (P-168), 100 ppm of compound represented by formula (3) was added as a branching agent for reaction. The reaction conditions were as follows: pumping at a flow rate of 40 liters per hour into three cylindrical flow reactors each having a capacity of 110 liters that were connected in series, the reaction was maintained at an inlet temperature of 115° C., 130° C. and 150° C. respectively, the final conversion rate was at 80 weight %, after heating with a heater at 260° C. and removing the unreacted monomer and inert solvent by a devolatilization apparatus under 15 torr of vacuum, the thermoplastic resin composition (not extruded) including the branched copolymer was obtained after extrusion granulation.

### Embodiment 2

The synthesis method was the same as embodiment 1, the difference being that the added branching agent was the compound represented by formula (4) (the usage amount is illustrated as table 1).

### Comparative Example 1

The synthesis method was the same as embodiment 1, the difference being that the added branching agent was EM231 (trimethylolpropane triacrylate) manufactured by Eternal Materials, the usage amount is listed in table 1. The structure of EM231 is represented as follows:

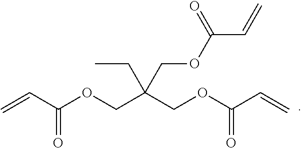 [SMILES: C=CC(=O)OCC(CC)(COC(=O)C=C)COC(=O)C=C]

### Comparative Example 2

The synthesis method was the same as embodiment 1, the difference being that no branching agent was added to the reaction.

### Evaluation Method

Under 220° C., a first extrusion (extruded once), a second extrusion (extruded for 2 times), and a third extrusion (extruded for 3 times) were sequentially performed on the obtained thermoplastic resin composition with an extruder, and the weight average molecular weight after the extrusion were measured respectively.

The measurement of the weight average molecular weight is achieved by the Gel Permeation Chromatography (GPC) manufactured by Waters having a differential refractive index detector (Waters RI-2414) and an ultraviolet visible light detector (Waters PDA-2996), the analysis conditions are as follows. Column: MZ-Gel Sdplus linear 5 Ξm 300×8.0 mm, Mobile phase: THF (flow rate 0.5 ml/min).

The usage amount of the branching agent, the weight average molecular weight (not extruded), the maintenance ratio of the weight average molecular weight (extruded once, extruded for 2 times and extruded for 3 times) of the thermoplastic resin composition in embodiment 1˜2 and comparative example 1˜2 are listed in table 1 respectively.

TABLE 1

| | Embodiment | Embodiment | Comparative | Comparative |
|---|---|---|---|---|
| | 1 | 2 | Example 1 | Example 2 |
| branching | compound | compound | EM231 | — |
| agent | represented | represented | | |
| | by formula | by formula | | |
| | (3) | (4) | | |
| usage amount | 100 | 100 | 75 | 0 |
| (ppm) | | | | |
| weight average | 400356 | 396716 | 425127 | 371370 |
| molecular | | | | |
| weight (not | | | | |
| extruded) | | | | |
| maintenance | 100.00% | 100.00% | 100.00% | 100.00% |
| ratio of | | | | |
| the weight | | | | |
| average | | | | |
| molecular | | | | |
| weight | | | | |
| (extruded for | | | | |
| 0 times) | | | | |
| maintenance | 94.70% | 94.30% | 92.00% | 93.10% |
| ratio of the | | | | |
| weight average | | | | |
| molecular | | | | |
| weight | | | | |
| (extruded | | | | |
| once) | | | | |
| maintenance | 91.10% | 90.90% | 88.60% | 89.70% |
| ratio of the | | | | |
| weight average | | | | |
| molecular | | | | |
| weight | | | | |
| (extruded | | | | |
| for 2 times) | | | | |
| maintenance | 88.40% | 88.10% | 85.70% | 87.10% |
| ratio of the | | | | |
| weight average | | | | |
| molecular | | | | |
| weight | | | | |
| (extruded | | | | |
| for 3 times) | | | | |

It can be known from table 1 that the thermoplastic resin composition of embodiment 1˜2 includes the branched copolymer obtained from a copolymerization using the unsaturated urethane compound of the invention as a branching agent with the copolymerizable monomer, wherein the unsaturated urethane compound includes the compound obtained from a reaction of the methacrylate compound containing a hydroxyl group and the triisocyanate cyclic compound, such as the compound represented by formula (3) or formula (4). Therefore, the maintenance ratio of the weight average molecular weight of the thermoplastic resin composition in embodiment 1˜2 is excellent after being extruded for 3 times in high temperature, high heat resistance is provided, the degree of molecular weight decrease is low after multiple high-temperature extrusion. In addition, based on an amount of the copolymerizable monomer being 100 parts by weight, the amount of the unsaturated urethane compound is 0.001 parts by weight to 0.8 parts by weight, the maintenance ratio of the weight average molecular weight of the produced thermoplastic resin composition is excellent after being extruded for 3 times in high temperature, high heat resistance is provided, the degree of molecular weight decrease is low after multiple high-temperature extrusion.

The unsaturated urethane compound of the invention was not used as the branching agent in comparative example 1, therefore, the maintenance ratio of the weight average molecular weight of the thermoplastic resin composition in comparative example 1 is poor after being extruded for 3 times in high temperature, high heat resistance is not provided, the degree of molecular weight decrease is significant after multiple high-temperature extrusion.

No branching agent was used in comparative example 2, therefore, the maintenance ratio of the weight average molecular weight of the thermoplastic resin composition in comparative example 2 is poor after being extruded for 3 times in high temperature, high heat resistance is not provided, the degree of molecular weight decrease is significant after multiple high-temperature extrusion.

Based on the above, the thermoplastic resin composition provided by the invention includes the branched copolymer obtained from a copolymerization of an unsaturated urethane compound and a copolymerizable monomer, wherein the unsaturated urethane compound has the effect of a branching agent in polymer synthesis, so that the polymer transforms into a branched structure from a linear structure, and the molding product has high heat resistance, the production stability can be aided.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A thermoplastic resin composition, comprising:
a branched copolymer, obtained from a copolymerization of an unsaturated urethane compound and a copolymerizable monomer;
wherein the unsaturated urethane compound comprises a compound obtained from a reaction of a methacrylate compound containing a hydroxyl group and a triisocyanate cyclic compound.

2. The thermoplastic resin composition according to claim 1, wherein the triisocyanate cyclic compound is represented by formula (1), 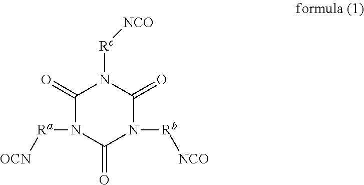
in formula (1), R^{a}, R^{b}, and R^{c} each independently represents a C₂˜C₁₂ alkylene group.

3. The thermoplastic resin composition according to claim 1, wherein the methacrylate compound containing a hydroxyl group comprises at least one selected from a group consisting of 2-hydroxyethyl methacrylate and pentaerythritol trimethacrylate.

4. The thermoplastic resin composition according to claim 1, wherein the unsaturated urethane compound is represented by formula (2), 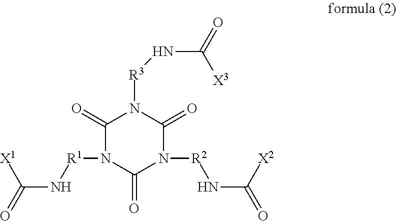
in formula (2), R¹, R² and R³ each independently represents a C₂˜C₁₂ alkylene group, and X¹, X² and X³ are each independently selected from a group consisting of a residue obtained by removing a hydrogen from a hydroxyl group of 2-hydroxyethyl methacrylate and a residue obtained by removing a hydrogen from a hydroxyl group of pentaerythritol trimethacrylate.

5. The thermoplastic resin composition according to claim 4, wherein in formula (2), R¹, R², and R³ each independently represents a C₂˜C₁₀ alkylene group.

6. The thermoplastic resin composition according to claim 4, wherein in formula (2), R¹, R², and R³ each independently represents a C₄˜C₈ alkylene group.

7. The thermoplastic resin composition according to claim 4, wherein in formula (2), R¹, R², and R³ are each independently a hexamethylene group.

8. The thermoplastic resin composition according to claim 7, wherein the unsaturated urethane compound is represented by formula (3) or formula (4):

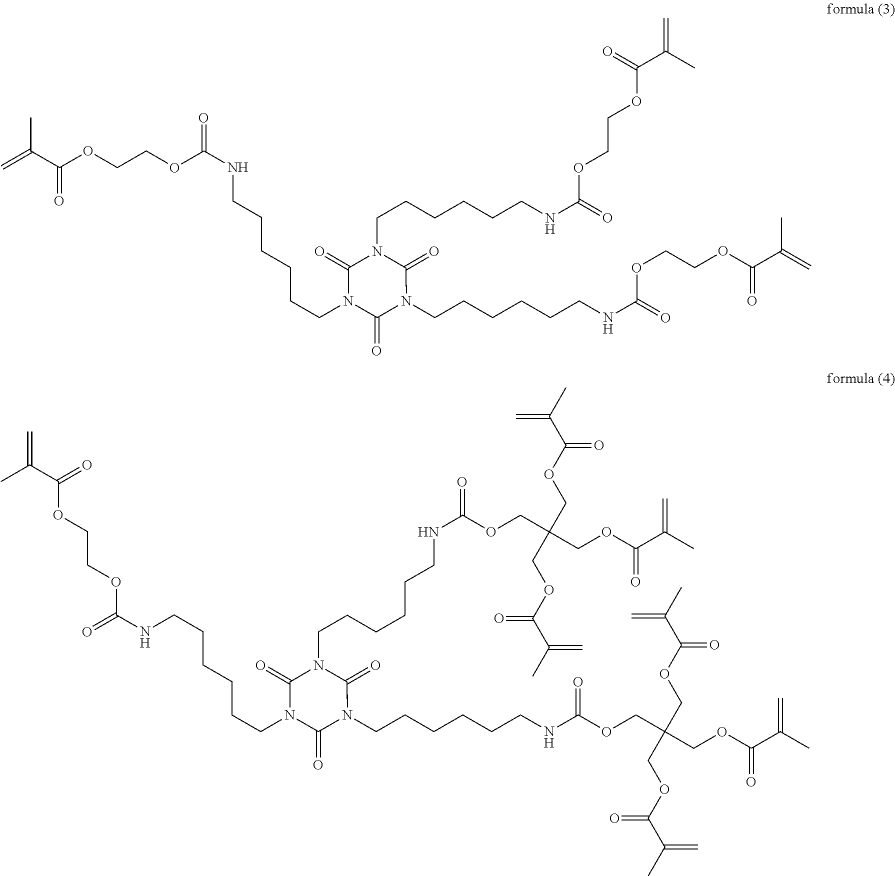

9. The thermoplastic resin composition according to claim 1, wherein based on an amount of the copolymerizable monomer being 100 parts by weight, an amount of the unsaturated urethane compound is 0.001 parts by weight to 0.8 parts by weight.

10. The thermoplastic resin composition according to claim 9, wherein based on an amount of the copolymerizable monomer being 100 parts by weight, an amount of the unsaturated urethane compound is 0.002 parts by weight to 0.4 parts by weight.

11. The thermoplastic resin composition according to claim 1, wherein the copolymerizable monomer comprises at least one selected from a group consisting of a styrene based monomer, an acrylonitrile based monomer and a (meth)acrylate based monomer.

12. The thermoplastic resin composition according to claim 1, wherein a weight average molecular weight of the thermoplastic resin composition is 380,000 to 445,000.

13. A molding product, formed by the thermoplastic resin composition according to claim 1.

14. A manufacturing method of a thermoplastic resin composition, comprising:
producing a branched copolymer by a copolymerization of an unsaturated urethane compound and a copolymerizable monomer,
wherein the unsaturated urethane compound comprises a compound obtained from a reaction of a methacrylate compound containing a hydroxyl group and a triisocyanate cyclic compound.

15. The manufacturing method of the thermoplastic resin composition according to claim 14, wherein the triisocyanate cyclic compound is represented by formula (1), 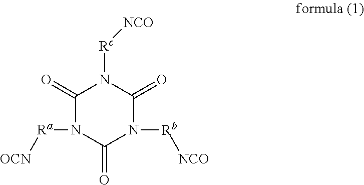
in formula (1), R^{a}, R^{b}, and R^{c} each independently represents a C₂˜C₁₂ alkylene group.

16. The manufacturing method of the thermoplastic resin composition according to claim 14, wherein the methacrylate compound containing a hydroxyl group comprises at least one selected from a group consisting of 2-hydroxyethyl methacrylate and pentaerythritol trimethacrylate.

17. The manufacturing method of the thermoplastic resin composition according to claim 14, wherein the unsaturated urethane compound is represented by formula (2), 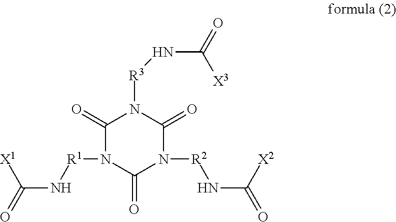
in formula (2), R¹, R² and R³ each independently represents a C₂˜C₁₂ alkylene group, and X¹, X² and X³ are each independently selected from a group consisting of a residue obtained by removing a hydrogen from a hydroxyl group of 2-hydroxyethyl methacrylate and a residue obtained by removing a hydrogen from a hydroxyl group of pentaerythritol trimethacrylate.

18. The manufacturing method of the thermoplastic resin composition according to claim 17, wherein in formula (2), R¹, R², and R³ are each independently a hexamethylene group.

19. The manufacturing method of the thermoplastic resin composition according to claim 18, wherein the unsaturated urethane compound is represented by formula (3) or formula (4):

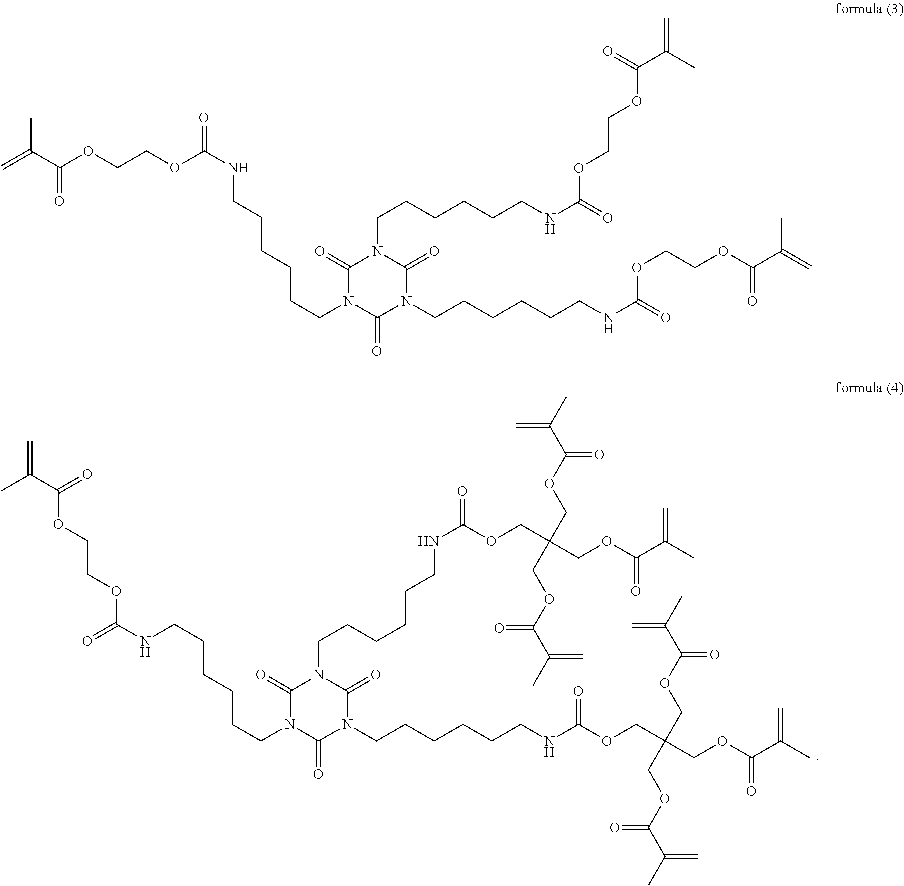

20. The manufacturing method of the thermoplastic resin composition according to claim 14, wherein based on an amount of the copolymerizable monomer being 100 parts by weight, an amount of the unsaturated urethane compound is 0.001 parts by weight to 0.8 parts by weight.
